(19) United States
(12) Patent Application Publication
(10) Pub. No.: US 2023/0407144 A1
(43) Pub. Date: Dec. 21, 2023

(54) ADHESIVE FILM FOR SURFACE PROTECTIVE FILM, AND OPTICAL MEMBER COMPRISING SAME

(71) Applicant: SAMSUNG SDI CO., LTD., Yongin-si, Gyeonggi-do (KR)

(72) Inventors: Irina NAM, Suwon-si (KR); Young Hoon KIM, Suwon-si, (KR); Won KIM, Suwon-si, (KR); Bong Soo PARK, Suwon-si, (KR); Il Jin KIM, Suwon-si, (KR); Dong Heon YUN, Suwon-si, (KR); Dong Il YUN, Suwon-si, (KR)

(21) Appl. No.: 18/249,207

(22) PCT Filed: Nov. 22, 2021
(86) PCT No.: PCT/KR2021/017141

§ 371 Date: Apr. 14, 2023

(30) Foreign Application Priority Data
Nov. 23, 2020 (KR) 10-2020-0158270

(51) Int. Cl. C09J 7/38; C09J 7/10; C09J 11/06

(52) U.S. Cl. CPC C09J 7/38; C09J 7/10; C09J 11/06; C09J 2475/00

(57) ABSTRACT

Provided are: an adhesive film for a surface protective film, formed from a composition comprising a urethane-based binder and an isocyanate-based curing agent; and an optical member comprising same, wherein the adhesive film has a release force increase rate, of formula 1, of 180% or less, an initial release force of 1-12 gf/inch, a nitrogen amount of 0.5-1.5 wt % and a modulus, at 25° C., of 0.05-0.8 MPa.

### TECHNICAL FIELD

The present invention relates to an adhesive film used as surface protective film and an optical member including the same.

### BACKGROUND ART

The use, storage and manufacturing environments of optical displays are becoming harsh. In addition, interest in new optical displays, such as wearable devices, foldable devices, and the like, is also increasing. As a result, an adhesive protective film for protecting a panel of the optical display is required to have various properties. In particular, with the development of a panel having a compact structure and high flexibility, it is desirable to develop an adhesive protective film that allows less damage to the panel and less change in properties thereof even under severe conditions upon removal of the adhesive protective film.

Accordingly, acrylate-based or urethane acrylate-based adhesive protective films have been developed in the art. However, when the acrylate-based or urethane acrylate-based adhesive protective film attached to an adherend is left for a long period of time, peel strength of the adhesive protective film to the adherend increases excessively, thereby causing damage to and/or deformation of the adherend upon removal of the adhesive protective film therefrom while deteriorating processability due to difficulty in removal of the protective film

The background technique of the present invention is disclosed in Korean Patent Laid-open Publication No. 2012-0050136 and the like.

### DISCLOSURE

### Technical Problem

It is one object of the present invention to provide an adhesive film for surface protection that provides good effects in temporary protection of an adherend and in removal from the adherend without deformation of and/damage to the adherend.

It is another object of the present invention to provide an adhesive film for surface protection that ensures a low increase rate of peel strength after being attached to an adherend.

It is a further object of the present invention to provide an adhesive film for surface protection that ensures good wettability and good anti-scattering properties with respect to an adherend.

It is a further object of the present invention to provide an adhesive film for surface protection that has low haze to ensure good cuttability and processability.

### Technical Solution

One aspect of the present invention relates to an adhesive film for surface protection.

1. The adhesive film for surface protection is formed of a composition for adhesive films including a urethane-based binder and an isocyanate curing agent, and the adhesive film has an increase rate of peel strength of 180% or less, as calculated by Equation 1:

Increase rate of peel strength=[(P2−P1)/P1]×100 [Equation 1]

(wherein Equation 1,

P1 is an initial peel strength of the adhesive film (unit: gf/inch), and

P2 is peel strength of the adhesive film, as measured after leaving the adhesive film at 50° C. for 3 days and at 25° C. for 30 minutes (unit: gf/inch));

the adhesive film having an initial peel strength of 1 gf/inch to 12 gf/inch,

the adhesive film having a nitrogen (N) atom content of 0.5 wt % to 1.50 wt % relative to all atoms therein,

the adhesive film having a modulus of 0.05 MPa to 0.8 MPa at 25° C.

2. In 1, the adhesive film may have a haze of 5% or less in the visible spectrum.

3. In 1 and 2, the adhesive film may have a peel strength of 12 gf/inch or less, as measured after leaving the adhesive film at 50° C. for 3 days then at 25° C. for 30 minutes.

4. In 1 to 3, the urethane-based binder may include a unit derived from a polyether-based polyol.

5. In 4, the urethane-based binder may further include a unit derived from polyester-based polyol.

6. In 1 to 5, the urethane-based binder may have a hyper-branched structure.

7. In 1 to 6, the urethane-based binder may be prepared from a polyol including 40 wt % to 95 wt % of a triol and 5 wt % to 60 wt % of a diol.

8. In 1 to 7, a mole ratio of a total mole number of isocyanate groups in the isocyanate curing agent to a total mole number of hydroxyl groups in the urethane-based binder may be in the range of 0.7 to 1.2.

9. In 1 to 8, the isocyanate curing agent may include an isocyanurate of an aliphatic polyisocyanate curing agent, an alicyclic polyisocyanate curing agent, an aromatic polyisocyanate curing agent, or an aromatic-aliphatic polyisocyanate curing agent.

10. In 1 to 9, the isocyanate curing agent may be present in an amount of 2 parts by weight to 10 parts by weight relative to 100 parts by weight of the urethane-based binder.

11. In 1 to 10, the composition may include at least one selected from among a crosslinking catalyst, a plasticizer, and a leveling agent.

12. In 11, the plasticizer may include at least one selected from among an ester of a C₆ to C₁₈ monobasic or polybasic acid and a branched alcohol having 18 or fewer carbon atoms, an ester of a C₁₄ to C₁₈ unsaturated fatty acid or branched acid and a tetravalent or less alcohol, and an ester of a C₆ to C₁₀ monobasic acid or polybasic acid and a polyalkylene glycol.

Another aspect of the present invention relates to an optical member including an optical film and the adhesive film for surface protection formed on one surface of the optical film.

### Advantageous Effects

The present invention provided an adhesive film for surface protection that provides good effects in temporary protection of an adherend and in removal from the adherend without deformation of and/damage to the adherend.

The present invention provided an adhesive film for surface protection that ensures a low increase rate of peel strength after being attached to an adherend.

The present invention provided an adhesive film for surface protection that ensures good wettability and good anti-scattering properties with respect to an adherend.

The present invention provided an adhesive film for surface protection that has low haze to ensure good cuttability and processability.

### DESCRIPTION OF DRAWINGS

FIG. 1 is a cross-sectional view of a specimen for measurement of modulus of adhesive films for surface protection in examples.

### BEST MODE

Hereinafter, embodiments of the present invention will be described in detail. However, it should be understood that the present invention is not limited to the following embodiments and may be embodied in different ways. The following embodiments are provided to provide a thorough understanding of the invention to those skilled in the art.

Herein, ‘modulus’ of the adhesive film means a tensile modulus measured at 25° C.

Herein, ‘adherend’ refers to a glass plate, a plastic plate, or a panel of display devices, without being limited thereto.

As used herein to represent a specific numerical range, the expression “X to Y” means a value greater than or equal to X and less than or equal to Y (X≤ and ≤Y).

An adhesive film for surface protection (hereinafter, ‘adhesive film’) according to the present invention provides good effects in temporary protection of an adherend and in removal from the adherend without deformation of and/or damage to the adherend. The adhesive film according to the present invention has a low increase rate of peel strength if attached to an adherend, thereby enabling removal from the adherend without deformation of and/or damage to the adherend even after the adhesive film is attached to the adherend for a long period of time.

The adhesive film according to the present invention has good wettability with respect to an adherend, thereby securing efficient attachment without bubble generation and/or lifting, and has good anti-scattering properties upon cutting after being attached to the adherend, thereby improving cuttability and processability.

The adhesive film according to the present invention has low haze to allow easy examination of foreign matter in a panel with the adhesive film attached to an adherend, thereby providing good processability.

Hereinafter, an adhesive film according to one embodiment of the present invention will be described.

The adhesive film has a modulus of 0.05 MPa to 0.8 MPa at 25° C. Within this range, the adhesive film has good wettability to prevent generation of bubbles and/or lifting if attached to an adherend and exhibits good anti-scattering properties to secure good cuttability and processability. Specifically, the adhesive film may have a modulus of, for example, 0.05 MPa, 0.1 MPa, 0.15 MPa, 0.2 MPa, 0.25 MPa, 0.3 MPa, 0.35 MPa, 0.4 MPa, 0.5 MPa, 0.55 MPa, 0.6 MPa, 0.65 MPa, 0.7 MPa, 0.75 MPa, or 0.8 MPa, specifically 0.1 MPa to 0.8 MPa, more specifically 0.5 MPa to 0.8 MPa, as measured at 25° C. Herein, ‘anti-scattering properties’ means that no particles are generated on a laminate of an adhesive film and an adherend in anti-scattering property testing using a pencil hardness tester in accordance with JIS K5400 by moving an SUS pen across the surface of the laminate under conditions of a load of the SUS pen against the protective film: 1 kg, a scratch angle between a surface of the adhesive film and the SUS pen: 45°, a scratch speed of the SUS pen on the adhesive protective film: 48 mm/min, and a diameter of the SUS pen: 1 mm.

The adhesive film has an initial peel strength of 1 gf/inch to 12 gf/inch and an increase rate of peel strength of 180% or less, as calculated by Equation 1:

Increase rate of peel strength=[(P2−P1)/P1]×100 [Equation 1]

(wherein Equation 1,

P1 is an initial peel strength of the adhesive film (unit: gf/inch), and

P2 is peel strength of the adhesive film, as measured after leaving the adhesive film at 50° C. for 3 days then at 25° C. for 30 minutes (unit: gf/inch).

Herein, ‘initial peel strength’ means peel strength of the adhesive film measured before the adhesive film is left at 50° C. for 3 days. Within this range of initial peel strength, the adhesive film is not easily detached from an adherend, thereby providing an effect of protecting the adherend while preventing increase in increase rate of peel strength of Equation 1. Within this range of increase rate of peel strength, the adhesive film can secure good process stability and enables removal from the adherend without deformation of and/or damage to the adherend even after the adhesive film is attached to the adherend for a long period of time.

Specifically, the adhesive film has an initial peel strength P1 of, for example, 1 gf/inch, 1.5 gf/inch, 2 gf/inch, 2.5 gf/inch, 3 gf/inch, 3.5 gf/inch, 4 gf/inch, 4.5 gf/inch, 5 gf/inch, 5.5 gf/inch, 6 gf/inch, 6.5 gf/inch, 7 gf/inch, 7.5 gf/inch, 8 gf/inch, 8.5 gf/inch, 9 gf/inch, 9.5 gf/inch, 10 gf/inch, 10.5 gf/inch, 11 gf/inch, 11.5 gf/inch, or 12 gf/inch, more specifically 1 gf/inch to 5 gf/inch, 2 gf/inch to 5 gf/inch, still more specifically 2 gf/inch to 4.5 gf/inch. Specifically, the adhesive film has an increase rate of peel strength of, for example, 1%, 10%, 20%, 30%, 40%, 50%, 60%, 70%, 80%, 90%, 100%, 110%, 120%, 130%, 140%, 150%, 160%, 170%, or 180%, more specifically 1% to 180%, still more specifically 5% to 176%, 10% to 170%, 20% to 160%, 50% to 160%, or 60% to 150%, as calculated by Equation 1.

In one embodiment, the adhesive film has a peel strength P2, which is greater than or equal to P1 and 12 gf/inch or less, for example, 1 gf/inch, 1.5 gf/inch, 2 gf/inch, 2.5 gf/inch, 3 gf/inch, 3.5 gf/inch, 4 gf/inch, 4.5 gf/inch, 5 gf/inch, 5.5 gf/inch, 6 gf/inch, 6.5 gf/inch, 7 gf/inch, 7.5 gf/inch, 8 gf/inch, 8.5 gf/inch, 9 gf/inch, 9.5 gf/inch, 10 gf/inch, 10.5 gf/inch, 11 gf/inch, 11.5 gf/inch, 12 gf/inch, specifically 1 gf/inch to 12 gf/inch, 1 gf/inch to 9 gf/inch, 1 gf/inch to 8 gf/inch, 1 gf/inch to 7 gf/inch, 1 gf/inch to 6 gf/inch, or 1 gf/inch to 5 gf/inch, as measured after leaving the adhesive film at 50° C. for 3 days then at 25° C. for 30 minutes (unit: gf/inch). Within this range, the adhesive film enables removal from an adherend without deformation of and/or damage to the adherend even after the adhesive film is attached to the adherend for a long period of time.

The adhesive film may have a haze of 5% or less in the visible spectrum, specifically 0% to 2%, or 0% to 1%. Within this range, the adhesive film allows easy examination of foreign matter in a panel with the adhesive film attached to an adherend, thereby providing good processability.

The adhesive film has a thickness of about 100 μm or less, for example, greater than about 0 μm to 75 μm. Within this range, the adhesive film can protect an adherend if attached thereto and can be easily removed therefrom.

In order to provide an adhesive film having the initial peel strength, the increase rate of peel strength, the modulus and the haze within the above ranges, the adhesive film has a nitrogen (N) atom content of 0.5 wt % to 1.50 wt % relative to all atoms therein. Within this range of nitrogen (N) content, the adhesive film can satisfy all conditions of initial peel strength, increase rate of peel strength, modulus and haze. For example, the adhesive film may have a nitrogen (N) atom content of 0.50 wt %, 0.55 wt %, 0.60 wt %, 0.65 wt %, 0.70 wt %, 0.75 wt %, 0.80 wt %, 0.85 wt %, 0.90 wt %, 0.95 wt %, 1.00 wt %, 1.05 wt %, 1.10 wt %, 1.15 wt %, 1.20 wt %, 1.25 wt %, 1.30 wt %, 1.35 wt %, 1.40 wt %, 1.45 wt %, or 1.50 wt %.

As described in detail below, the adhesive film is formed of a composition for adhesive films including a urethane-based binder and an isocyanate curing agent. The urethane-based binder has a nitrogen (N)-containing urethane bond and a hydroxyl group (—OH), which reacts with the isocyanate curing agent. The isocyanate curing agent contains a nitrogen (N)-containing isocyanate group (—NCO). If the urethane-based binder is cured by the isocyanate curing agent, an OH group of the urethane-based binder reacts with an NCO group of the isocyanate curing agent to generate an —NH(C═O)—O group. As a result, the nitrogen content is not changed. As such, nitrogen of the adhesive film is derived from both the urethane-based binder and the isocyanate curing agent. According to the present invention, the adhesive film is formed to have a nitrogen (N) atom content of 0.5 wt % to 1.50 wt % relative to all atoms therein, thereby simultaneously satisfying the above conditions of initial peel strength, increase rate of peel strength, modulus and haze. In one embodiment, the adhesive film has a nitrogen (N) atom content of greater than 0.6 wt % to 1.27 wt %. Preferably, the adhesive film has a nitrogen (N) atom content of 0.6 wt % to 1.27 wt %.

In the adhesive film, ‘nitrogen content’ can be measured through elemental analysis of a specimen, which is obtained by burning 2 mg of the adhesive film at 900° C., in a gas chromatographic column.

In one embodiment, nitrogen may be present only in the urethane-based binder and the isocyanate curing agent of the composition for adhesive films and may not be present in other components excluding the urethane-based binder and the isocyanate curing agent.

In the adhesive film, the nitrogen (N) content within the above range may be obtained by controlling the kind and/or content of each of the urethane-based binder and the isocyanate curing agent in the composition for adhesive films. In one embodiment, the adhesive film may have a nitrogen (N) content within the above range by controlling a mole ratio ([NCO]/[OH]) in the composition to be in the range of 0.7 to 1.2.

In the composition, ‘mole ratio ([NCO]/[OH])’ is a ratio of a total mole number of isocyanate groups [NCO] in the isocyanate curing agent to a total mole number of hydroxyl groups [OH] in the urethane-based binder in the composition. Preferably, the adhesive film has a mole ratio [NCO]/[OH] of 0.7, 0.74, 0.75, 0.8, 0.85, 0.9, 0.95, 1.0, 1.05, 1.1, 1.15, or 1.2, specifically 0.7 to less than 1.15, more preferably 0.7 to 1.11, still more preferably 0.74 to 1.0.

Next, a composition for adhesive films according to one embodiment of the invention will be described.

The composition for adhesive films includes a urethane-based binder and an isocyanate curing agent.

The urethane-based binder may include a polyurethane polyol binder having a urethane bond and at least one hydroxyl group (—OH). The urethane-based binder may have a weight average molecular weight of 30,000 to 150,000, for example, 30,000, 35,000, 40,000, 45,000, 50,000, 55,000, 60,000, 65,000, 70,000, 75,000, 80,000, 85,000, 90,000, 95,000, 100,000, 105,000, 110,000, 115,000, 120,000, 125,000, 130,000, 135,000, 140,000, 145,000, or 150,000, specifically 60,000 to 120,000. Within this range, it is possible to realize advantageous effects of the present invention.

In one embodiment, the urethane-based binder may include a unit derived from a polyether-based polyol. The unit derived from the polyether-based polyol allows the adhesive film to achieve the above effects of the present invention.

In another embodiment, the urethane-based binder may include a unit derived from a polyether-based polyol and a unit derived from a polyester-based polyol. The unit derived from the polyester-based polyol serves to help the unit derived from the polyether-based polyol easily realize the above effects of the invention.

In one embodiment, the urethane-based binder may be free from a (meth)acrylate group.

The polyurethane polyol binder may be prepared through reaction of at least one polyol with at least one polyisocyanate compound.

The polyol may include at least one selected from among a polyether-based polyol, a polyester-based polyol, a polyacryl-based polyol, a polycaprolactone-based polyol, and a polycarbonate-based polyol. Preferably, the polyol may include at least one polyether-based polyol and may further include at least one polyester-based polyol.

The polyether-based polyol has an alkylene oxide group and may include a polyether polyol having at least two hydroxyl groups, such as a bifunctional polyether-based polyol (polyether diol) or a trifunctional polyether-based polyol (polyether triol), for example, polyethylene glycol, polypropylene glycol, polytetramethylene glycol, and the like, and a trifunctional polyether-based polyol (polyether triol) of glycerine alkylene oxide adducts, and the like. As a result, the urethane-based binder becomes a hyper-branched binder, thereby facilitating realization of the advantageous effects of the invention. Here, ‘hyper-branched’ means a polymer having many terminal functional groups and a dendrite branched structure.

The polyether-based polyol may have a number average molecular weight of 400 to 10,000, for example, 400, 1,000, 2,000, 3,000, 4,000, 5,000, 6,000, 7,000, 8,000, 9,000, or 10,000, specifically 1,000 to 7,000. Within this range, the composition for adhesive films can secure good properties in terms of peel strength, wettability and modulus. Preferably, the polyether-based polyol includes a mixture of a polyether diol and a polyether triol, thereby facilitating realization of the advantageous effect of the invention.

The polyester-based polyol may include a polyol obtained through esterification of at least one polyol and at least one acid component. The polyol may include at least one selected from among ethyleneglycol, propyleneglycol, diethyleneglycol, 1,3-butanediol, 1,4-butanediol, neopentylglycol, 3-methyl-1,5-pentanediol, 2-butyl-2-ethyl-1,3-propanediol, 2,4-diethyl-1,5-pentanediol, 1,2-hexanediol, 1,6-hexanediol, 2-ethyl-1,3-hexanediol, 1,8-octanediol, 1,9-nonanediol, 2-methyl-1,8-octanediol, 1,8-decanediol, octadecanediol, glycerin, trimethylolpropane, pentaerythritol, and hexane triol. The acid component may include succinic acid, methyl succinic acid, adipic acid, azelaic acid, sebacic acid, 1,12-dodecanedioic acid, 1,14-tetradecanedioic acid, dimer acid, 2-methyl-1,4-cyclohexanedicarboxyl acid, 2-ethyl-1,4-cyclohexanedicarboxylic acid, terephthalic acid, isophthalic acid, phthalic acid, 1,4-naphthalenedicarboxylic acid, 4,4′-biphenyldicarboxylic acid, or acid anhydrides thereof.

The polyester-based polyol may include a polyester-based polyol having at least two hydroxyl groups, at least one selected from among a bifunctional polyesther-based polyol (polyester diol) or a trifunctional polyester-based polyol (polyester triol). As a result, the urethane-based binder becomes a hyper-branched binder, thereby facilitating realization of the advantageous effects of the present invention.

The polyester-based polyol may have a number average molecular weight of 1,000 to 5,000, for example, 1,000, 1500, 2,000, 2500, 3,000, 3,500, 4,000, 4,500, or 5,000, specifically 2,000 to 3,000. Within this range, the composition for adhesive films can secure good properties in terms of peel strength and modulus and can suppress increase in peel strength over time.

The polyisocyanate compound may include a polyisocyanate compound having a plurality of isocyanate groups (—NCO). The polyisocyanate compound may be a typical polyisocyanate compound known in the art and may include at least one selected from among an aliphatic polyisocyanate compound, an alicyclic polyisocyanate compound, an aromatic polyisocyanate compound, and an aromatic-aliphatic polyisocyanate compound. In particular, an aliphatic polyisocyanate compound is preferably used.

The aliphatic polyisocyanate compound may include at least one selected from among hexamethylene diisocyanate, trimethylene diisocyanate, tetramethylene diisocyanate, pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate.

In one embodiment, the urethane-based binder may include 0 mol % to 15 mol %, e.g., 0 mol %, 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, or 15 mol % of a unit derived from a polyester-based polyol, 15 mol % to 45 mol %, e.g., 15 mol %, 16 mol %, 17 mol %, 18 mol %, 19 mol %, 20 mol %, 21 mol %, 22 mol %, 23 mol %, 24 mol %, 25 mol %, 26 mol %, 27 mol %, 28 mol %, 29 mol %, 30 mol %, 31 mol %, 32 mol %, 33 mol %, 34 mol %, 35 mol %, 36 mol %, 37 mol %, 38 mol %, 39 mol %, 40 mol %, 41 mol %, 42 mol %, 43 mol %, 44 mol %, or 45 mol % of a unit derived from a polyether triol, 4 mol % to 44 mol %, e.g., 4 mol %, 5 mol %, 6 mol %, 7 mol %, 8 mol %, 9 mol %, 10 mol %, 11 mol %, 12 mol %, 13 mol %, 14 mol %, 15 mol %, 16 mol %, 17 mol %, 18 mol %, 19 mol %, 20 mol %, 21 mol %, 22 mol %, 23 mol %, 24 mol %, 25 mol %, 26 mol %, 27 mol %, 28 mol %, 29 mol %, 30 mol %, 31 mol %, 32 mol %, 33 mol %, 34 mol %, 35 mol %, 36 mol %, 37 mol %, 38 mol %, 39 mol %, 40 mol %, 41 mol %, 42 mol %, 43 mol %, or 44 mol % of a unit derived from a polyether diol, and 35 mol % to 50 mol %, e.g., 35 mol %, 36 mol %, 37 mol %, 38 mol %, 39 mol %, 40 mol %, 41 mol %, 42 mol %, 43 mol %, 44 mol %, 45 mol %, 46 mol %, 47 mol %, 48 mol %, 49 mol %, or 50 mol % of a unit derived from the polyisocyanate compound. Within this range, the composition for adhesive films can secure good properties in terms of peel strength and modulus and can suppress increase in peel strength over time.

The reaction may be performed at a predetermined temperature after adding a catalyst to a mixture including at least one kind of polyol and at least one kind of polyisocyanate compound. In the mixture, a mole ratio [NCO]/[OH] of a total mole number of isocyanate groups (—NCO) in the polyisocyanate compound to a total mole number of hydroxyl groups (—OH) in the polyol may be in the range of 0.5 to 0.96. Within this range, it is possible to achieve the nitrogen (N) content of the adhesive film according to the present invention. Preferably, [NCO]/[OH] is in the range of 0.5 to 0.95, for example, 0.5, 0.55, 0.6, 0.65, 0.7, 0.75, 0.8, 0.85, 0.9, specifically in the range of 0.5 to 0.9.

In one embodiment, the at least one polyol in the mixture may include a polyether-based polyol. With the polyether-based polyol as the polyol, the compound can more easily realize the effects of the present invention.

In another embodiment, the at least one polyol in the mixture may further include a polyester-based polyol. For example, in the mixture, the polyol may include 40 mol % to mol %, e.g., 40 mol %, 41 mol %, 42 mol %, 43 mol %, 44 mol %, 45 mol %, 46 mol %, 47 mol %, 48 mol %, 49 mol %, 50 mol %, 51 mol %, 52 mol %, 53 mol %, 54 mol %, 55 mol %, 56 mol %, 57 mol %, 58 mol %, 59 mol %, 60 mol %, 61 mol %, 62 mol %, 63 mol %, 64 mol %, or 65 mol % of the polyether-based polyol, and 1 mol % to 15 mol %, e.g., 1 mol %, 2 mol %, 3 mol %, 4 mol %, 5 mol %, 6 mol %, 7 mol %, 8 mol %, 9 mol %, 10 mol %, 11 mol %, 12 mol %, 13 mol %, 14 mol %, or 15 mol % of the polyester-based polyol. Within this range, the composition for adhesive films can secure good properties in terms of peel strength and modulus and can suppress increase in peel strength over time.

In one embodiment, the polyol may be free from a polyester-based diol. In one embodiment, the polyol may be free from a polyester-based triol.

As a tin-based compound, the catalyst may include dibutyltin dilaurate (DBTDL) and tin 2-ethyl hexanoate, without being limited thereto.

The urethane-based binder may be prepared from a polyol including 40 wt % to 95 wt %, e.g., 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, or 95 wt % of a triol, and 5 wt % to 60 wt %, e.g., 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, or 60 wt % of a diol. Preferably, the polyol includes greater than 50 wt % to 95 wt %, more preferably 52 wt % to 95 wt %, of the triol and 5 wt % to less than 50 wt %, more preferably 5 wt % to 48 wt %, of the diol. Within this range, the composition allows easy preparation of a hyper-branched urethane-based binder according to the present invention, thereby facilitating realization of the advantageous effects of the invention. The triol may include a polyether-based triol. The diol may include a polyether-based diol alone or a mixture of a polyether-based diol and a polyester-based diol.

The urethane-based binder may be prepared from a composition including 40 wt % to 90 wt %, e.g., 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, or 90 wt % of the triol, 2 wt % to 50 wt %, e.g., 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, or 50 wt % of the diol, and 2 wt % to 10 wt %, e.g., 2 wt %, 3 wt %, 4 wt %, 5 wt %, 6 wt %, 7 wt %, 8 wt %, 9 wt %, or 10 wt % of the isocyanate curing agent, based on the total amount of the polyol and the isocyanate curing agent. Within this range, the composition allows easy preparation of a hyper-branched urethane-based binder according to the present invention, thereby facilitating realization of the advantageous effects of the present invention. The triol may include a polyether triol. The diol may include a polyether diol alone or a mixture of a polyether diol and a polyester diol.

For preparation of the hyper-branched urethane-based binder, the polyol mixture is placed in a reactor and held at a temperature of 80° C. to 100° C. under nitrogen purging conditions for 10 min to 30 min to completely remove remaining moisture, followed by reducing the internal temperature of the reactor to 60° C. to 70° C. Then, the polyisocyanate compound and the catalyst are added to the reactor, followed by primary polymerization at to 75° C. for 2 hours to 4 hours and secondary polymerization at 75° C. to 85° C. for 60 min to 120 min.

The isocyanate curing agent provides a matrix of the adhesive film through reaction of an isocyanate group with a hydroxyl group of the urethane-based binder, thereby providing peel strength to the adhesive film.

The isocyanate curing agent is a polyfunctional isocyanate curing agent having a plurality of isocyanate groups (—NCO) and may include a typical isocyanate curing agent known to a person having ordinary knowledge in the art.

In one embodiment, the isocyanate curing agent may include at least one selected from among aliphatic polyisocyanate, alicyclic polyisocyanate, aromatic polyisocyanate and aromatic-aliphatic polyisocyanate compounds or polyol adducts thereof, burets thereof, or isocyanurates thereof. For example, the aliphatic polyisocyanate compound may include at least one selected from among hexamethylene diisocyanate, trimethylene diisocyanate, tetramethylene diisocyanate, pentamethylene diisocyanate, 1,2-propylene diisocyanate, 2,3-butylene diisocyanate, 1,3-butylene diisocyanate, dodecamethylene diisocyanate, and 2,4,4-trimethylhexamethylene diisocyanate. Preferably, the isocyanate curing agent may include isocyanurates of the aforementioned isocyanate curing agent.

The isocyanate curing agent may be present in an amount of 2 parts by weight to parts by weight, for example, 2, 2.5, 3, 3.5, 4, 4.5, 5, 5.5, 6, 6.5, 7, 7.5, 8, 8.5, 9, 9.5, or 10 parts by weight, specifically 4 parts by weight to 7 parts by weight, relative to 100 parts by weight of the urethane-based binder. Within this range, the isocyanate curing agent can secure satisfactory properties of the composition for adhesive films after curing.

The composition may further include a crosslinking catalyst.

The crosslinking catalyst can promote reaction between the urethane-based binder and the isocyanate curing agent. The crosslinking catalyst may include at least one metal-based catalyst. The metal-based catalyst may include at least one of tin-based catalysts and non-tin-based catalysts. The tin-based catalysts and the non-tin-based catalysts may be selected from typical tin-based and non-tin-based catalysts known to those skilled in the art. For example, the tin-based catalysts may include dibutyltin dichloride, dibutyltin oxide, dibutyltin dilaurate, dibutyltin sulfide, dibutyltin diacetate, and dibutyltin maleate, without being limited thereto.

The crosslinking catalyst may be present in an amount of 0.005 parts by weight to parts by weight, specifically 0.01 parts by weight to 0.1 parts by weight, relative to 100 parts by weight of the urethane-based binder. Within this range, the crosslinking agent can secure satisfactory pot life and rapid curing.

The composition may further include a leveling agent.

The leveling agent may improve leveling properties of the adhesive film. The leveling agent may include an acryl-based leveling agent, a fluorine-based leveling agent, a silicone-based leveling agent, a silicone-acrylate-based leveling agent, and the like.

The leveling agent may be present in an amount of 0.1 parts by weight to 5 parts by weight, specifically 0.3 parts by weight to 1 part by weight, relative to 100 parts by weight of the urethane binder. Within this range, the leveling agent can secure low initial peel strength of the adhesive film.

The composition may further include a plasticizer.

Although the adhesive film according to the present invention is required to have low initial peel strength, the plasticizer can improve anti-scattering properties by reducing modulus of the adhesive film.

The plasticizer may include an ester of a C₆ to C₁₈ monobasic or polybasic acid and a branched alcohol having 18 or fewer carbon atoms, an ester of a C₁₄ to C₁₈ unsaturated fatty acid or branched acid and a tetravalent or lower alcohol, and an ester of a C₆ to C₁₈ monobasic or polybasic acid and a polyalkylene glycol. For example, the plasticizer may include isopropyl myristate, isopropyl palmitate, isostearyl palmitate, isostearyl laurate, diisostearyl adipate, and diisocetyl sebacate, without being limited thereto.

The plasticizer may be present in an amount of 1 part by weight to 30 parts by weight, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 parts by weight, specifically 10 parts by weight to 30 parts by weight, relative to 100 parts by weight of the urethane-based binder. Within this range, it is possible to secure low initial peel strength and low modulus of the adhesive film.

The composition may further include additives. The additives may include antistatic agents, UV absorbers, UV stabilizers, antioxidants, heat stabilizers, and surfactants, without being limited thereto.

The adhesive film may be prepared by depositing the composition for adhesive films to a predetermined thickness on a base film and drying the composition at 110° C. to 140° C., followed by leaving the dried composition at 30° C. to 70° C. for 1 to 3 days, but is not limited thereto.

An optical member according to one embodiment of the invention includes an optical film and an adhesive film for surface protection formed on at least one surface of the optical film, wherein the adhesive film may include the adhesive film for surface protection according to the embodiments of the present invention.

The optical film is a display panel and may include a polyimide film. In one embodiment, the optical film may be composed of a light emitting diode layer and a polyimide film formed on at least one surface of the light emitting diode layer. The optical member may further include an organic or inorganic insulating film between the optical film and the adhesive film. The optical member may further include a release film (liner) formed on the other surface of the adhesive film. The release film serves to prevent the adhesive film from being contaminated by foreign matter. The release film may be an optical film that is formed of the same material as the optical film or formed of a different material than the optical film. For example, the release film may be a film formed of at least one selected from among a polyethylene terephthalate resin, a polycarbonate resin, a polyimide resin, a poly(meth)acrylate resin, a cyclic olefin polymer resin, and an acrylic resin. The release film may have a thickness of 10 μm to 100 μm, preferably 10 μm to 50 μm. Within this range, the release film can support the adhesive film.

### MODE FOR INVENTION

Next, the present invention will be described in more detail with reference to examples. However, it should be noted that these examples are provided for illustration only and should not be construed in any way as limiting the invention.

### Preparative Example 1: Preparation of Urethane-Based Binder

In a 1,000 mL jacket reactor, a polyether-based polyol was placed in a weight as listed in Table 1 and mixed under nitrogen purging conditions. Then, toluene was further added thereto to prepare a mixture, which in turn was stirred for 10 minutes and heated to for 30 minutes under nitrogen purging conditions to remove remaining moisture. Thereafter, the internal temperature of the reactor was reduced to 60° C. and hexamethylene diisocyanate (HDI) was added thereto in an amount as listed in Table 1. After additionally stirring the mixture at 60° C. for 10 min, dibutyltin dilaurate (DBTDL) was added to the reactor as a polymerization catalyst. Then, the internal temperature of the reactor was increased to 70° C. after 1 hour and was increased again to 80° C. after 1 hour, followed by performing polymerization reaction at 80° C. for 2 hours. Then, the resulting binder solution was diluted with toluene to prepare a solution with a solid content of 65 wt %, which in turn was cooled to room temperature to prepare a solid compound. The solid compound contains a hyper-branched urethane binder having a plurality of hydroxyl groups (—OH).

### Preparative Examples 2 to 14: Preparation of Urethane-Based Binder

Each of hyper-branched urethane binders was prepared in the same manner as in Preparative Example 1 except that the kind and content of each of a polyether polyol and a polyester polyol and the weight of hexamethylene diisocyanate were changed as listed in Table 1.

In the following Table 1, “-” means that a corresponding component is not present.

In preparation of the urethane binder, a mole ratio [NCO]/[OH] of a total mole number of isocyanate groups (—NCO) in a polyisocyanate compound, that is, hexamethylene diisocyanate, to a total mole number of hydroxyl groups (—OH) in a polyol comprising a polyether-based polyol and a polyester-based polyol was calculated and results are shown in Table 1.

The weight average molecular weight (Mw) of the urethane binder was measured by GPC and results are shown in Table 1.

TABLE 1

| Preparative | Composition for urethane-based binder (wt %) | | | | | | | [NCO]/ | |
|---|---|---|---|---|---|---|---|---|---|
| Example | I | | II | | III | IV | HDI | [OH] | Mw |
| 1 | 18.3 | (diol 1) | 76.9 | (triol 1) | — | — | 4.8 | 0.50 | 68,506 |
| 2 | 43 | (diol 1) | 50.1 | (triol 1) | — | — | 6.9 | 0.60 | 83,112 |
| 3 | 55.3 | (diol 1) | 33.1 | (triol 1) | — | — | 11.6 | 0.96 | 106,693 |
| 4 | 3 | (diol 1) | 80.6 | (triol 1) | 11.9 | — | 4.5 | 0.56 | 62,304 |
| 5 | 3 | (diol 1) | 80.4 | (triol 1) | 11.9 | — | 4.7 | 0.56 | 85,508 |
| 6 | 3 | (diol 1) | 80.2 | (triol 1) | 11.9 | — | 4.9 | 0.60 | 95,255 |
| 7 | 2.9 | (diol 1) | 79.5 | (triol 1) | 11.8 | — | 5.8 | 0.71 | 110,358 |
| 8 | 5.8 | (diol 2) | 78.3 | (triol 1) | 11.6 | — | 4.3 | 0.54 | 68,627 |
| 9 | 8.4 | (diol 3) | 76.1 | (triol 1 ) | 11.3 | — | 4.2 | 0.54 | 75,542 |
| 10 | 2.8 | (diol 2) | 89.4 | (triol 2) | 5.7 | — | 2.1 | 0.54 | 78,357 |
| 11 | 2.8 | (diol 1) | 77 | (triol 1) | 15.7 | — | 4.5 | 0.54 | 65,304 |
| 12 | — | | 75 | (triol 1) | — | 21.4 | 3.6 | 0.40 | 25,566 |
| 13 | — | | 63.7 | (triol 1) | — | 31.9 | 4.4 | 0.47 | 36,551 |
| 14 | 34.55 | (diol 2) | 17.3 | (triol 1) | 34.6 | — | 13.55 | 1.33 | 88,530 |

*In Table 1,
I: polyether-based diol - diol 1: PPG-1000D; diol 2: PPG-2000D; diol 3: PPG-3000D (all available from Kumho Petrochemical Co., Ltd., Korea);
II: polyether-based triol - triol 1: PPG-3020; triol 2: PPG-7000 (all available from Kumho Petrochemical Co., Ltd., Korea)
III: polyester-based diol (Polyol P-2010, Kuraray Co., Ltd.)
IV: polyester-based triol (Polyol F-2010, Kuraray Co., Ltd.)

### Example 1

A composition for adhesive films was prepared by mixing 100 parts by weight of the urethane-based binder prepared in Preparative Example 1, 4.5 parts by weight of an isocyanate curing agent (isocyanurate adduct of hexamethylene diisocyanate, Coronate HX), 0.01 parts by weight of a crosslinking catalyst (dibutyltin dilaurate (DBTDL)), 0.30 parts by weight of a leveling agent (silicone-acrylate based leveling agent, BYK-3700, BYK), and 15 parts by weight of a plasticizer (isopropyl myristate) in terms of solid content.

The prepared composition was deposited to a predetermined thickness on an upper surface of a release film (PET film, thickness: 75 μm) using an applicator and dried at 130° C. for 4 min. Then, with a release film (PET film with an antistatic coating layer formed thereon, thickness: 25 μm) placed on the composition layer, the resultant was left at 50° C. for 2 days, thereby fabricating an adhesive sheet having a laminate of the base film, the adhesive film (thickness: 75 μm) and the release film stacked in the stated order.

### Examples 2 to 14

Each of adhesive sheets having a laminate of the base film, the adhesive film (thickness: 75 μm) and the release film stacked in the stated order was prepared in the same manner as in Example 1 except that the kind of urethane binder and the content of at least one of the curing agent, the crosslinking catalyst, the leveling agent and the plasticizer were changed as listed in Table 2 (unit: parts by weight).

### Comparative Examples 1 to 6

Each of adhesive sheets having a laminate of the base film, the adhesive film (thickness: 75 μm) and the release film stacked in the stated order was prepared in the same manner as in Example 1 except that the kind of urethane binder and the content of at least one of the curing agent, the crosslinking catalyst, the leveling agent and the plasticizer were changed as listed in Table 2 (unit: parts by weight).

### Comparative Example 7

A polyol blend was prepared by mixing 13.5 moles of a polyether diol (PPG-1000D), 29.2 moles of a polyether triol (PPG-3020) and 57.3 moles of a polyether triol (PPG-10000). An adhesive sheet having a laminate of the base film, the adhesive film (thickness: 75 μm) and the release film stacked in the stated order was prepared in the same manner as in Example 1 except that the content of at least one of the curing agent, the crosslinking catalyst, the leveling agent and the plasticizer relative to 100 parts by weight of the prepared polyol blend was changed as listed in Table 2 (unit: parts by weight) in preparation of a composition. The composition of Comparative Example 7 was free from a urethane binder.

### Comparative Example 8

An adhesive sheet having a laminate of the base film, the adhesive film (thickness: 75 μm) and the release film stacked in the stated order was prepared in the same manner as in Comparative Example 7 except that the content of the curing agent was changed as listed in Table 2 (unit: parts by weight). A composition of Comparative Example 8 was free from a urethane binder.

Each of the adhesive films fabricated in Examples and Comparative Examples was evaluated as to the following physical properties and results are shown in Table 3.

(1) [NCO]/[OH]: In each of the compositions for adhesive films prepared in Example and Comparative Example, a ratio of a total mole number of isocyanate groups [NCO] in the isocyanate curing agent to a total mole number of hydroxyl groups [OH] in the urethane-based binder was calculated. The number of moles of [OH] was calculated by a method for calculation of the number of [OH] functional groups. The number of moles of [NCO] was calculated by a method for calculation of the number of [NCO] functional groups.

(2) Initial peel strength (P1, unit: gf/inch): Each of the adhesive sheets fabricated in Examples and Comparative Examples was cut to a size of 200 mm×25 mm (length×width) and the release PET film was removed therefrom to expose the adhesive film. Then, a glass plate was attached to an exposed surface of the adhesive film and was then pressed by a 2 kg roller, thereby obtaining a specimen having a laminate of the glass plate, the adhesive film and the base film stacked in the stated order.

After preparation of the specimen and 30 minutes, peel strength of the adhesive film with respect to the glass plate was measured under conditions of a peeling rate of 2,400 mm/min, a peeling angle of 180°, and a temperature of 25° C. using a texture analyzer (TA). Here, the peel strength was measured on a total of three specimens, followed by calculation of an average of the measured values.

(3) Peel strength after 3 days at 50° C. (P2, unit: gf/inch): A specimen having a laminate of the glass plate, the adhesive film and the base film stacked in the stated order was obtained in the same manner as in (2).

The prepared specimen was left in an oven at 50° C. for 3 days. Then, the specimen was removed from the oven and left at 25° C. for 30 minutes, followed by measurement of peel strength in the same manner as in (2).

(4) Increase rate of peel strength (unit: %): Increase rate of peel strength was calculated using the initial peel strength (P1) and the peel strength after 3 days (P2) obtained in (2) and (3) according to Equation 1.

(5) Haze (unit:%): The release film and the base film were removed from each of the adhesive sheets prepared in Examples and Comparative Examples to obtain the adhesive film, which in turn was attached to a glass plate, thereby preparing a specimen. Haze of the specimen was measured in the visible spectrum using a haze meter NDH-9000. A haze of 2% or less was rated as “o”, a haze of greater than 2% to 3% was rated as “A”, and a haze of greater than 3% was rated as “x”.

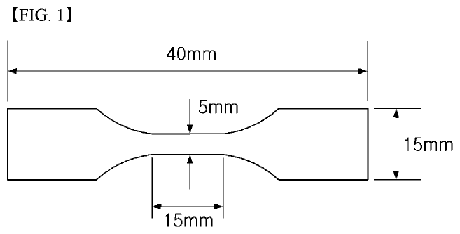

(6) Modulus (unit: MPa): Each of the compositions for adhesive films prepared in Examples and Comparative Examples was deposited to a predetermined thickness on one surface of a fluorinated film (FL-75BML, Dongwon Intec Co., Ltd) and then a PET film was attached to the coating layer, followed by drying at 130° C. for 4 minutes and aging at 50° C. for 2 days, thereby fabricating a laminate in which a 75 μm thick adhesive protective film was interposed between the fluorinated film and the PET film. Then, the laminate was cut into a dog bone shape as shown in FIG. 1, followed by removal of the fluorinated film and the PET film, thereby preparing a specimen for measurement of modulus.

Referring to FIG. 1, the prepared specimen had a dog bone shape and had an overall length of 40 mm, an overall width of 15 mm, and a thickness of 75 μm.

Modulus of the specimen was measured using a modulus tester (Instron Corp.). Specifically, the left end of the dog bone-shaped specimen of FIG. 1 was connected to a first jig of the modulus tester and the right end of the specimen was connected to a second jig of the modulus tester. Here, a portion of the left end connected to the first jig had the same area as a portion of the right end connected to the second jig. Then, with the first jig locked in place, the specimen was stretched on the second jig under conditions of load cell: 1 kN, tensile rate: 50 mm/min, and temperature: 25° C. until breakage of a portion of the dog bone-shaped specimen of FIG. 1, which is indicated by a width of 15 mm and a thickness of 5 mm, thereby obtaining modulus of the specimen.

(7) Nitrogen (N) content (unit: wt %): 2 mg of an adhesive film was obtained by removing all of the base film and the release film from the adhesive sheet prepared in Examples and Comparative Examples. 2 mg of the adhesive film was placed in a gas chromatograph and burnt at 900° C. for several seconds, followed by quantitative elemental analysis in gas chromatography to obtain a ratio of the content of nitrogen (N) atoms relative to all atoms of the adhesive film.

TABLE 2

| | | Curing | | Leveling | |
|---|---|---|---|---|---|
| Item | Binder | agent | Catalyst | agent | Plasticizer |
| Example 1 | Preparative | 4.5 | 0.01 | 0.30 | 15 |
| | Example 1 | | | | |
| Example 2 | Preparative | 4.5 | 0.01 | 0.30 | 15 |
| | Example 2 | | | | |
| Example 3 | Preparative | 4.5 | 0.01 | 0.30 | 15 |
| | Example 4 | | | | |
| Example 4 | Preparative | 4.5 | 0.01 | 0.30 | 15 |
| | Example 5 | | | | |
| Example 5 | Preparative | 4.5 | 0.01 | 0.30 | 15 |
| | Example 6 | | | | |
| Example 6 | Preparative | 4.5 | 0.01 | 0.30 | 15 |
| | Example 7 | | | | |
| Example 7 | Preparative | 4.5 | 0.01 | 0.30 | 15 |
| | Example 8 | | | | |
| Example 8 | Preparative | 4.5 | 0.01 | 0.30 | 15 |
| | Example 9 | | | | |
| Example 9 | Preparative | 4.5 | 0.01 | 0.30 | 15 |
| | Example 10 | | | | |
| Example 10 | Preparative | 4.5 | 0.01 | 0.30 | 15 |
| | Example 11 | | | | |
| Example 11 | Preparative | 4.0 | 0.01 | 0.30 | 15 |
| | Example 4 | | | | |
| Example 12 | Preparative | 6.0 | 0.01 | 0.30 | 15 |
| | Example 4 | | | | |
| Example 13 | Preparative | 4.5 | 0.01 | 0.30 | 10 |
| | Example 4 | | | | |
| Example 14 | Preparative | 4.5 | 0.01 | 0.30 | 30 |
| | Example 4 | | | | |
| Comparative | Preparative | 4.5 | 0.01 | 0.30 | 15 |
| Example 1 | Example 3 | | | | |
| Comparative | Preparative | 15.0 | 0.0 | 0.30 | 15 |
| Example 2 | Example 4 | | | | |
| Comparative | Preparative | 25 | 0.01 | 0.30 | 25 |
| Example 3 | Example 12 | | | | |
| Comparative | Preparative | 25 | 0.01 | 0.30 | 35 |
| Example 4 | Example 13 | | | | |
| Comparative | Preparative | 5.2 | 0.01 | 0.30 | 15 |
| Example 5 | Example 14 | | | | |
| Comparative | Preparative | 10.4 | 0.01 | 0.30 | 15 |
| Example 6 | Example 14 | | | | |
| Comparative | Polyol | 8.9 | 0.01 | 0.30 | 0 |
| Example 7 | blend | | | | |
| Comparative | Polyol | 13.5 | 0.01 | 0.30 | 0 |
| Example 8 | blend | | | | |

TABLE 3

| | | | | Increase | | | |
|---|---|---|---|---|---|---|---|
| | | | | rate of | | | Nitrogen |
| | [NCO]/ | | | peel | | | (N) |
| Item | [OH] | P1 | P2 | strength | Haze | Modulus | content |
| Example 1 | 0.74 | 2.9 | 6.8 | 134 | ○ | 0.58 | 0.98 |
| Example 2 | 0.80 | 4.5 | 11.3 | 151 | ○ | 0.57 | 1.27 |
| Example 3 | 0.81 | 2.8 | 6.1 | 118 | ○ | 0.61 | 0.94 |
| Example 4 | 0.84 | 2.5 | 5.1 | 104 | ○ | 0.63 | 0.96 |
| Example 5 | 0.87 | 2.3 | 4.3 | 87 | ○ | 0.75 | 1.00 |
| Example 6 | 0.98 | 2.2 | 3.6 | 64 | ○ | 0.79 | 1.12 |
| Example 7 | 0.82 | 2.9 | 6.8 | 134 | ○ | 0.60 | 0.92 |
| Example 8 | 0.83 | 3.3 | 8.1 | 145 | ○ | 0.58 | 0.90 |
| Example 9 | 1.11 | 4.1 | 11.3 | 176 | ○ | 0.51 | 0.61 |
| Example 10 | 0.81 | 2.5 | 5.1 | 104 | ○ | 0.72 | 0.94 |
| Example 11 | 0.78 | 3.2 | 7.2 | 125 | ○ | 0.56 | 0.91 |
| Example 12 | 0.90 | 2.1 | 3.9 | 86 | ○ | 0.72 | 1.03 |
| Example 13 | 0.81 | 3.2 | 7.2 | 125 | ○ | 0.63 | 0.94 |
| Example 14 | 0.81 | 2.5 | 4.4 | 76 | ○ | 0.57 | 0.94 |
| Comparative | 1.15 | 7.6 | 35.0 | 361 | ○ | 0.56 | 1.93 |
| Example 1 | | | | | | | |
| Comparative | 1.45 | 1.7 | 2.2 | 29 | ○ | 0.84 | 1.53 |
| Example 2 | | | | | | | |
| Comparative | 1.59 | 2.6 | 9.5 | 265 | ○ | 0.73 | 1.71 |
| Example 3 | | | | | | | |
| Comparative | 1.68 | 2.1 | 7.5 | 257 | ○ | 0.68 | 1.62 |
| Example 4 | | | | | | | |
| Comparative | 1.59 | 3.5 | 15.3 | 337 | ○ | 0.55 | 2.24 |
| Example 5 | | | | | | | |
| Comparative | 1.85 | 2.9 | 11.2 | 286 | ○ | 0.61 | 2.49 |
| Example 6 | | | | | | | |
| Comparative | 1.25 | 4.2 | 17.2 | 310 | ○ | 0.75 | 0.68 |
| Example 7 | | | | | | | |
| Comparative | 1.89 | 2.4 | 9.2 | 283 | ○ | 0.87 | 0.99 |
| Example 8 | | | | | | | |

As shown in Table 3, the adhesive films for surface protection according to the present invention satisfied both conditions for initial peel strength and increase rate of peel strength of Equation 1. As a result, the adhesive films according to the present invention provided good effects in temporary protection of an adherend and in removal from the adherend without deformation of and/damage to the adherend. Accordingly, although not shown in Table 3, the adhesive films according to the present invention can provide good effects in protection of an adherend if attached thereto and can be removed from the adherend without deformation of and/or damage to the adherend after being attached thereto for a long period of time.

In addition, the adhesive films according to the present invention satisfied all conditions for modulus at 25° C. and the nitrogen content relative to all atoms in the adhesive film. Accordingly, although not shown in Table 3, the adhesive films exhibited good wettability, anti-scattering properties, cuttability and processability.

Furthermore, the adhesive films for surface protection according to the present invention had low haze to secure good cuttability and processability.

On the contrary, the adhesive films of Comparative Examples failed to provide the above effects of the adhesive film according to the present invention.

It should be understood that various modifications, changes, alterations, and equivalent embodiments can be made by those skilled in the art without departing from the spirit and scope of the present invention.

1. An adhesive film for surface protection formed of a composition for adhesive films comprising a urethane-based binder and an isocyanate curing agent,
the adhesive film having an increase rate of peel strength of 180% or less, as calculated by Equation 1:
Increase rate of peel strength=[(P2−P1)/P1]×100 [Equation 1]
where, in Equation 1,
P1 is an initial peel strength of the adhesive film (unit: gf/inch), and
P2 is peel strength of the adhesive film, as measured after leaving the adhesive film at 50° C. for 3 days and at 25° C. for 30 minutes (unit: gf/inch),
the adhesive film having an initial peel strength of 1 gf/inch to 12 gf/inch, a nitrogen (N) atom content of 0.5 wt % to 1.50 wt % relative to all atoms therein, and a modulus of 0.05 MPa to 0.8 MPa at 25° C.

2. The adhesive film for surface protection as claimed in claim 1, wherein the adhesive film has a haze of 5% or less in the visible spectrum.

3. The adhesive film for surface protection as claimed in claim 1, wherein the adhesive film has a peel strength of 12 gf/inch or less, as measured after leaving the adhesive film at 50° C. for 3 days then at 25° C. for 30 minutes.

4. The adhesive film for surface protection as claimed in claim 1, wherein the urethane-based binder comprises a unit derived from a polyether-based polyol.

5. The adhesive film for surface protection as claimed in claim 4, wherein the urethane-based binder further comprises a unit derived from a polyester-based polyol.

6. The adhesive film for surface protection as claimed in claim 1, wherein the urethane-based binder is a hyper-branched binder.

7. The adhesive film for surface protection as claimed in claim 1, wherein the urethane-based binder is prepared from a polyol comprising 40 wt % to 95 wt % of a triol and 5 wt % to 60 wt % of a diol.

8. The adhesive film for surface protection as claimed in claim 1, wherein a mole ratio of a total mole number of isocyanate groups in the isocyanate curing agent to a total mole number of hydroxyl groups in the urethane-based binder is in the range of 0.7 to 1.2.

9. The adhesive film for surface protection as claimed in claim 1, wherein the isocyanate curing agent comprises an isocyanurate of an aliphatic polyisocyanate curing agent, an alicyclic polyisocyanate curing agent, an aromatic polyisocyanate curing agent, or an aromatic-aliphatic polyisocyanate curing agent.

10. The adhesive film for surface protection as claimed in claim 1, wherein the isocyanate curing agent is present in an amount of 2 parts by weight to 10 parts by weight relative to 100 parts by weight of the urethane-based binder.

11. The adhesive film for surface protection as claimed in claim 1, wherein the composition comprises at least one selected from among a crosslinking catalyst, a plasticizer, and a leveling agent.

12. The adhesive film for surface protection as claimed in claim 11, wherein the plasticizer comprises at least one selected from among an ester of a C₆ to C₁₈ monobasic or polybasic acid and a branched alcohol having 18 or fewer carbon atoms, an ester of a C₁₄ to C₁₈ unsaturated fatty acid or branched acid and a tetravalent or less alcohol, and an ester of a C₆ to C₁₀ monobasic acid or polybasic acid and a polyalkylene glycol.

13. An optical member comprising: an optical film; and an adhesive film for surface protection as claimed in claim 1 formed on one surface of the optical film.
